(19) United States
(12) Patent Application Publication
(10) Pub. No.: US 2010/0277314 A1
(43) Pub. Date: Nov. 4, 2010

(54) ALARM APPARATUS

(76) Inventor: Gabriel Bradley, Down (GB)

Correspondence Address: SMIRMAN IP LAW, PLLC, P.O. BOX 80364, ROCHESTER, MI, 48308, US

(21) Appl. No.: 12/742,115

(22) PCT Filed: Nov. 6, 2008
(86) PCT No.: PCT/GB2008/051037

§ 371 Date: May 10, 2010

(30) Foreign Application Priority Data
Nov. 8, 2007 (GB) 0722143.5
Dec. 5, 2007 (GB) 0725405.5

(51) Int. Cl. G08B 21/00

(52) U.S. Cl. 340/540

(57) ABSTRACT

An apparatus (1) for use in a multi user environment for alerting people of a predefined schedule of tasks to be undertaken. The apparatus (1) comprises a clock (2), a memory (3) for storing a schedule of alarm times and an arrangement (4) for comparing a current clock time against the schedule of alarm times. The apparatus (1) also has an arrangement (5) for generating an alarm signal when the current clock time corresponds to one of the alarm times. An alarm output arrangement (1, 121, 22) is provided for raising an alarm and an identification member (8, 21) is provided for identifying a user and deactivating the alarm.

The present invention relates to an alarm apparatus and in particular to an electronic alarm apparatus for use in a multi user environment for alerting and reminding people of a predefined schedule of work tasks to be undertaken.

Organisations are continuously trying to improve quality and service to their customers in order to improve standards and to satisfy the ever increasing demands of customers and of legislation imposed upon them by government bodies such as environment, health and trading standards. These organisations are required to have systems in place which will ensure that they are being run efficiently and effectively at all times. Many organisations require staff to carry out a series of pre-determined duties at specified times, in a specified way. If a team of staff are working together in an organisation, and all of them can carry out their own specific duties at the specified times and in a specified way, the team dynamic helps the organisation to flourish and prosper.

If, however, one or some of the team members forget to carry out their tasks, or forget to carry them out at the right times, or forget to carry them out until it is too late, the organisation begins to suffer, requiring extra managerial presence and assistance. There are checklists, procedures and notices which are necessary for running any organisation, but if a staff member does not remember to read down the checklist, then nothing is achieved. Alternatively, a procedure may become so familiar that notice of it is overlooked. The term organisation covers all fields of activity including businesses where schedules are geared towards efficiency and profitability and the likes of hospitals where schedules and other activities such as hand washing are geared towards staff and patient safety.

It is an object of the present invention to provide a way of reminding staff to carry out all of their important tasks at the correct times, to comply with and stay ahead of the competition and the legislation and also to identify members of staff that persistently do not comply with the schedule or regulations.

Accordingly, the present invention provides an apparatus for use in a multi user environment for alerting people of a predefined schedule of tasks to be undertaken, the apparatus comprising clock means, memory means for storing a schedule of alarm times, means for comparing a current clock time against the schedule of alarm times, means for generating an alarm signal when the current clock time corresponds to one of the alarm times, alarm output means for raising an alarm and identification means for identifying a user and deactivating the alarm.

Advantageously, the apparatus with the inbuilt identification means provides the combined functionality of deactivating the alarm to indicate that the task has been completed as well as identifying the person who deactivates the alarm. This provides store managers, hospital managers and the like with the facility to check that all of their staff are performing their duties as scheduled. This helps to identify the problem of lazy staff relying on more conscientious staff to cover for them. The apparatus readily discloses this type of staff behaviour because certain members of staff would be identified turning off the alarm on a more frequent basis than other members of staff who would only be identified deactivating the alarm sporadically.

Preferably, the apparatus has a database of unique user ids stored on the memory means. Advantageously, each unique user id correlates to a staff member.

Ideally, the apparatus has means for receiving user id information from the identification means.

Preferably, the apparatus has means for interpreting user id information from the identification means.

Preferably, the apparatus has a means for comparing user id information from the identification means with user id information stored in the database.

Ideally, the apparatus has means for generating a user id authentication signal in response to the comparing means generating a match between live user id information from the identification means and the user ids stored on the database.

Preferably, the apparatus has means for deactivating the alarm in response to a user id authentication signal being generated.

Ideally, the apparatus has input means for programming the time and frequency of the predefined schedule of tasks/alarms.

Preferably, the input means comprises one or more buttons for programming alarm times and frequencies.

Alternatively, the input means comprises a touch sensitive screen for programming alarm times and frequencies.

In use, when the current time corresponds to a predefined alarm time, the alarm output means raises an alarm indicating a task in the schedule requires attention. A person responsible for the task approaches the apparatus and enters their id information into the identification means. The identification means receives live input information, from the user and transmits the information to a comparator on the apparatus for comparing the live information to a database of user ids stored in the user information database. An authentication signal is generated upon the live input information corresponding to one of the pre-recorded user ids. The authentication signal is input to the alarm generating means to deactivate the alarm.

Preferably, the identification means is provided by a biometric sensor.

Ideally, the biometric sensor is selected from any one of the group of biometric sensors capable of identifying a person from their fingers, hands, feet, face, eyes, ears, teeth, veins, voice, heart muscle electrical signals (EKG), electrocardiogram (ECG), a neurological activity sensor (EEG) or from any biometric sensor capable of uniquely identifying an individual from their measurable biological data.

In the most preferred embodiment, the biometric sensor is a finger print recognition biometric sensor.

Preferably, the apparatus has a database of unique biometric signatures corresponding to the staff members stored on the memory means. Advantageously, the staff member's unique biometric signature is recorded at an initial biometric enrolment.

In use, when a member of staff is required to carry out a particular task an alarm is activated on the apparatus and the person charged with the task must interact with the biometric sensor in order to deactivate the alarm signal.

Preferably, the biometric signatures of people deactivating the alarms are logged in the memory means of the apparatus. Advantageously, the apparatus is capable of producing reports including statistical analysis of staff deactivation of alarms for management's consideration.

Preferably, specific tasks are assigned to specific members of staff. Advantageously, this means that the exact member of staff must be at the appointed place at the appointed time in order to turn off the alarm. In this arrangement, the predefined alarm can only be deactivated by a certain member of staff inserting their unique user id.

Ideally, the means for generating the alarm has an override function. Advantageously, this allows a member of staff in a senior position to override the alarm generating means in the event that the member of staff scheduled to deactivate the alarm is unavailable.

Preferably, the alarm output means comprises visual, audible or tactile output means.

Ideally, the alarm output means comprises sound generating means.

Preferably, the alarm output means comprises a visual display.

Ideally, the visual display comprises an LCD or LED display.

Preferably, the visual display comprises a touch sensitive screen.

In an alternative embodiment, the visual display comprises a plurality of lights with a different colour.

Preferably, the lights comprise a green light and a red light. It will of course be appreciated that any colour of light can be used and red and green are chosen as well known symbols of alert and clear.

Ideally, one colour of light indicates a normal mode of operation and the other colour of light indicates an alarm condition. Advantageously, this arrangement allows the apparatus to be used on tables in a restaurant to indicate the length of time which has elapsed since a waiter/waitress has been at a particular table. This allows a restaurant manager for example returning from their break to immediately assess whether their customers are receiving the correct level of attention.

Ideally, the clock means, the memory means, the time comparing means and the alarm signal generating means are provided by a microcontroller operably coupled to the alarm output means and the identification means.

Preferably, the microcontroller is operably coupled to the input means.

Ideally, the output means comprises an alarm generating means.

Preferably, the output means is a visual, audible or tactile alarm generating means.

Ideally, the microcontroller has timer means for comparing the current time to the predefined schedule of alarm times.

Preferably, a control program is stored on the memory means of the microcontroller and is executable thereon.

Ideally, the control program provides means for receiving user id information from the identification means.

Preferably, the control program provides means for interpreting user id information from the identification means.

Preferably, the control program provides comparator means for comparing live user id information from the identification means with user id information stored in the database.

Ideally, the control program provides means for generating a user id authentication signal in response to the comparator means generating a match between live user id information from the identification means and the user ids stored in the database.

Preferably, the microcontroller has means for deactivating the alarm in response to a user id authentication signal being generated by the control program.

Preferably, the control program is in operable communication with a graphical user interface for programming the schedule of tasks.

Ideally, the graphical user interface is an icon based menu application system for programming the schedule of tasks.

Preferably, the apparatus has communication means allowing remote access.

Ideally, the apparatus is accessible using wired and/or wireless communication protocols.

Preferably, the apparatus is contactable via landline telephone technology.

Ideally, the apparatus is accessible using any one of the group of wireless protocols including GPS, GSM, GPRS, Mode 3G-UMTS and IEEE 802.11.

Preferably, the apparatus has input/output ports. Advantageously, external peripherals such as computers, printers and keyboards are connectable to the apparatus via the ports. Ideally, at least one port is a USB port.

Ideally, the apparatus has means for transferring data onto and from the memory of the apparatus via input/output ports and/or wired and/or wireless communication protocols. Advantageously, this facilitates programming of the schedule of tasks by a manager either locally or remotely. Additionally, the apparatus can automatically transmit messages via wired and/or wireless communication protocols via messaging services to managers/owners under certain conditions such as when an alarm has been active for a certain period of time.

Ideally, means for releasably coupling the apparatus to a surface is provided on a cover of the apparatus.

Preferably, magnetic means are provided on the cover of the apparatus for releasably coupling the apparatus to a surface.

Ideally, the apparatus has battery means. Advantageously, the battery means power the electronic controllers of the apparatus.

Preferably, the battery means is rechargeable.

The invention will now be described with reference to the accompanying drawings which shows by way of example only two embodiments of an alarm apparatus in accordance with the invention. In the drawings:—

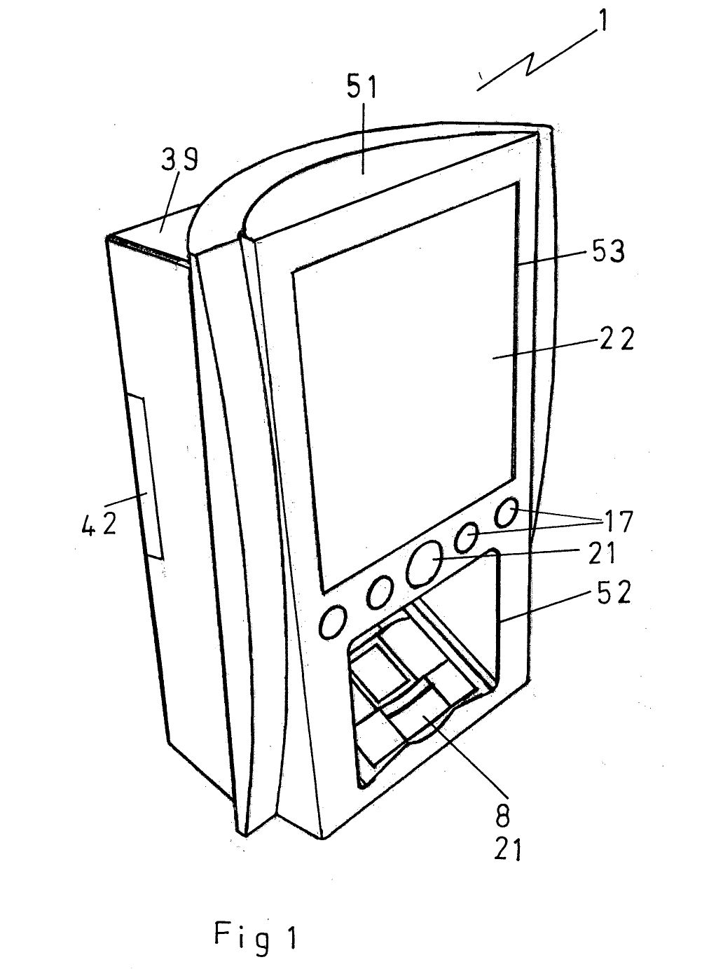

FIG. 1 is a perspective view of a first embodiment of alarm apparatus;

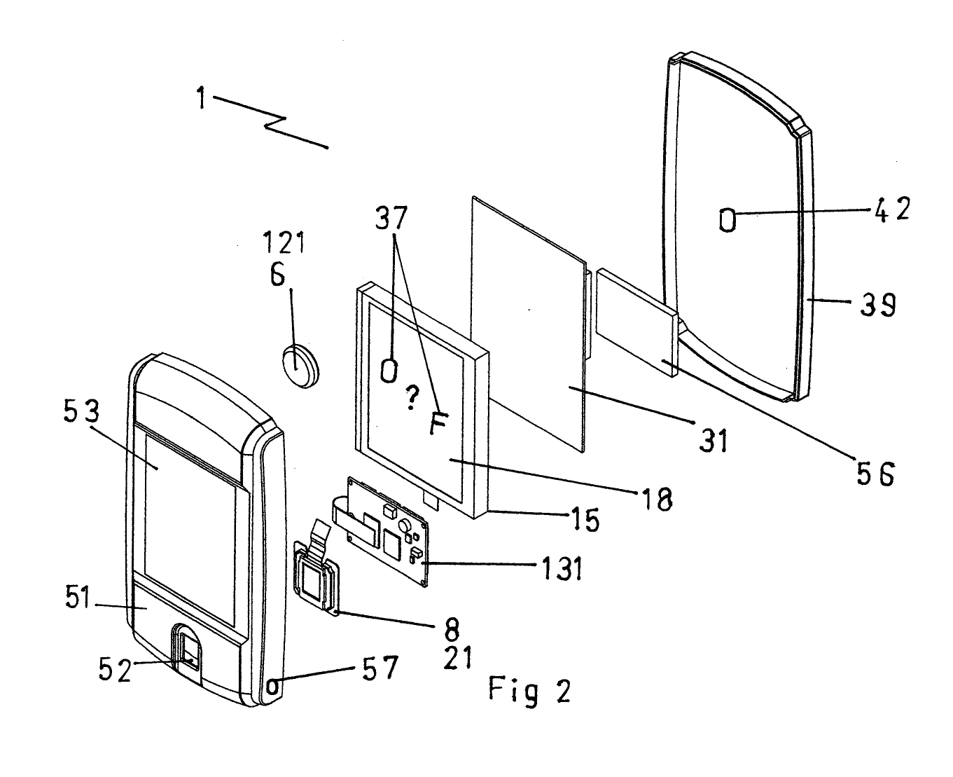

FIG. 2 is an exploded view of a second embodiment of alarm apparatus; and

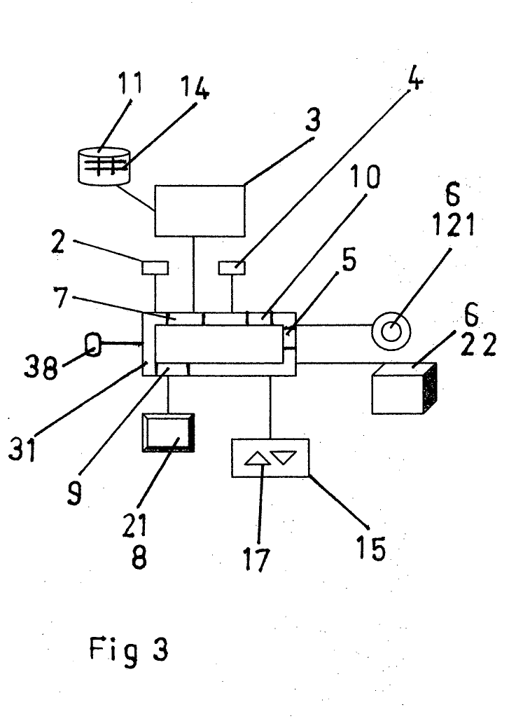

FIG. 3 is a schematic drawing of the microcontroller, inputs and outputs.

In the drawing, and initially referring to the, drawings in general, there is shown an alarm apparatus indicated generally by the reference numeral 1 for use in a multi user environment for alerting people of a predefined schedule of tasks to be undertaken. Referring especially to FIG. 3, the apparatus 1 comprises a clock 2, memory 3 for storing a schedule of alarm times, a comparator 4 for comparing a current clock time against the schedule of alarm times, an arrangement 5 for generating an alarm signal when the current clock time corresponds to one of the alarm times and an alarm output arrangement 6 for raising an alarm. The apparatus also comprises an identification member 8 for identifying a user and deactivating the alarm.

Advantageously, the apparatus 1 with the inbuilt identification member 8 provides the combined functionality of deactivating the alarm to indicate that the task has been completed as well as identifying the person who deactivates the alarm. This provides store managers, hospital managers and the like with the facility to check that all of their staff are performing their duties as scheduled. This helps to identify the problem of lazy staff relying on more conscientious staff to cover for them. The apparatus 1 readily discloses this type of staff behaviour because certain members of staff would be identified turning off the alarm on a more frequent basis than other members of staff who would only be identified deactivating the alarm sporadically.

The apparatus 1 has a database 11 of unique user ids 14 stored on the memory 3 with each unique user id 14 correlating to a staff member. The apparatus 1 has an arrangement 9, 131 for receiving and interpreting live user id information from the identification member 8. The apparatus 1 also has an arrangement 7 for comparing live user id information from the identification member 8 with user id information stored in the database 11. The apparatus 1 further has an arrangement 10 for generating a user id authentication signal in response to the user id comparator 7 generating a match between live user id information from the identification member 8 and the user ids 14 stored on the database 11. The apparatus 1 has an arrangement for deactivating the alarm signal generating arrangement 5 in response to a user id authentication signal being generated by signal generating arrangement 10.

The apparatus 1 has input member 15 for setting and/or modifying the times and frequency of the predefined schedule of tasks/alarms. The input member 15 comprises a plurality of buttons 17 for programming alarm times and frequencies in the embodiment shown in FIG. 1. Alternatively, the input member 15 comprises a touch screen 18 for programming alarm times and frequencies in the embodiment shown in FIG. 2.

In use, when the current time corresponds to a predefined alarm time, the alarm output arrangement 6 raises an alarm indicating a task in the schedule requires attention. A person responsible for the task approaches the apparatus 1 and enters their id information into the identification member 8. The identification member 8 receives input information from the user and transmits the information to the user id comparator 7 on the apparatus 1 for comparing the information to a database 11 of user ids 14 stored in the user information database 11. An authentication signal is generated upon the live input information corresponding to one of the pre-recorded user ids 14. The authentication signal is input to the alarm signal generating arrangement 5 to deactivate the alarm signal.

In the embodiments shown, the identification member 8 is provided by a biometric sensor 21 and this biometric sensor 21 is selected from any one of the group of biometric sensors 21 capable of identifying a person from their fingers, hands, feet, face, eyes, ears, teeth, veins, voice, heart muscle electrical signals (EKG), electrocardiogram (ECG), a neurological activity sensor (EEG) or from any biometric sensor 21 capable of uniquely identifying an individual from their measurable biological data. In the embodiments shown in FIGS. 1 and 2, the biometric sensor 21 is a finger print recognition biometric sensor.

The electronic apparatus 1 has a database 11 of unique biometric signatures 14 corresponding to the staff members stored on the memory 3 of the apparatus 1. Advantageously, the staff member's unique biometric signature 14 is recorded at an initial biometric enrolment. In use, when a member of staff is required to carry out a particular task an alarm is activated on the electronic apparatus 1 and the person charged with the task must interact with the biometric sensor 21 in order to deactivate the alarm signal.

The biometric signatures 14 of people deactivating the alarms are logged in the memory 3 of the apparatus 1. Advantageously, the apparatus 1 is capable of producing reports including statistical analysis of staff deactivation of alarms for management's consideration. Specific tasks are assigned to specific members of staff. Advantageously, this means that the exact member of staff must be at the appointed place at the appointed time in order to turn off the alarm. In this arrangement, the predefined alarm can only be deactivated by a certain member of staff inserting their unique user id 14. The alarm signal generating arrangement 5 has an override function allowing a member of staff in a senior position to override the alarm signal generating arrangement 5 in the event that the member of staff scheduled to deactivate the alarm is unavailable.

The alarm output arrangement 6 comprises visual, audible or tactile output members. In the embodiments shown in FIGS. 1 and 2, the alarm output arrangement 6 comprises a sound generating element 121 and a visual display 18, 22. The visual display can be selected from an LCD or LED display. FIG. 2 shows a visual display comprising a touch sensitive screen 18. It will of course be appreciated that the embodiments can contain any combination of input members 15 and alarm output arrangements 6. It will also be appreciated that a vibrating apparatus can be provided for general use or in particular with visually and/or audibly impaired staff members.

The apparatus 1 has a microcontroller 31 operably coupled to the alarm output arrangement 6, the identification member 8 and the input member 15. The microcontroller 31 has a control program stored on the memory 3, the control program being executable on the microcontroller 31. The microcontroller 31 also has an arrangement for deactivating the alarm in response to a user id authentication signal being generated by the control program. The microcontroller 31 is operably coupled to the alarm output arrangement 6 comprising alarm generating members selected from the group consisting of visual 18, 22, audible 121 or tactile alarm generating members. The comparator 4 of the microcontroller 31 has electronic timers for comparing the current time to the predefined schedule of alarm times.

The control program receives and/or interprets live user id information from the identification member 8, 131 and compares this live user id information from the identification member 8 with user id information 14 stored in the database 11. The control program generates a user id authentication signal in response to the user id comparator 7 generating a match between live user id information from the identification member 8 and the user ids 14 stored on the database 11. The control program is in operable communication with a graphical user interface 37 for programming the schedule of tasks and the graphical user interface 37 is an icon based menu application system for programming the schedule of tasks.

The apparatus 1 has a communication arrangement 38 allowing remote access using wired and/or wireless communication protocols. The apparatus 1 is accessible using any one of the group of wireless protocols including GPS, GSM, GPRS, Mode 3G-UMTS and IEEE 802.11. The apparatus 1 is equipped for using wireless or landline telecommunications technology.

Referring in particular to. FIG. 1 and FIG. 2, each apparatus 1 has a cover 51 having an aperture 52 for receiving an identification member 8 and an aperture 53 for receiving a screen 18, 22. An attachment member 42 for releasably coupling the apparatus 1 to a surface such as a wall or a fridge door is provided on a back cover 39 of the apparatus 1. The attachment member 42 is preferably magnetic but can equally be provided by hook and look or some similar fastening members. Referring more particularly to FIG. 2, the biometric sensor 21 has an associated microcontroller 131 and the electronic controllers 31, 131 of the apparatus 1 are powered by a rechargeable battery 56. The apparatus 1 also has an adapter 57 for directly coupling the apparatus 1 to the mains for charging or alternatively to a docking station for charging. It will be appreciated that the components described with reference to FIG. 2 are equally applicable to the embodiment of FIG. 1 and vice versa.

The features disclosed in the foregoing description or the following drawings and claims, expressed in their specific forms or in terms of a means for performing a disclosed function, or a method or a process of attaining the disclosed result, as appropriate, may separately, or in any combination of such features be utilised for realising the invention in diverse forms thereof.

1. An apparatus for use in a multi user environment for alerting people of a predefined schedule of tasks to be undertaken, the apparatus comprising:
clock means;
memory means for storing a schedule of alarm times;
means for comparing a current clock time against the schedule of alarm times;
means for generating an alarm signal when the current clock time corresponds to one of the alarm times; and
alarm output means for raising an alarm and identification means for identifying a user and deactivating the alarm.

2. An apparatus as claimed in claim 1, wherein a database of unique user ids is stored on the memory means.

3. An apparatus as claimed in claim 1, further comprising means for receiving user id information from the identification means.

4. An apparatus as claimed in claim 1, further comprising means for interpreting user id information from the identification means.

5. An apparatus as claimed in claim 2, further comprising means for comparing user id information from the identification means with user id information stored in the database.

6. An apparatus as claimed in claim 5, further comprising means for generating a user id authentication signal in response to the user id comparing means generating a match between user id information from the identification means and the user ids stored in the database.

7. An apparatus as claimed in claim 6, further comprising means for deactivating the alarm signal in response to a user id authentication signal being generated.

8. An apparatus as claimed in claim 1, further comprising input means for programming the predefined schedule of tasks/alarms.

9. An apparatus as claimed in claim 8, wherein the input means further comprises at least one button.

10. An apparatus as claimed in claim 8, wherein the input means further comprises a touch sensitive screen.

11. An apparatus as claimed in claim 1, wherein the identification means is provided by a biometric sensor.

12. An apparatus as claimed in claim 1, wherein the identification means is provided by a finger print recognition biometric sensor.

13. An apparatus as claimed in claim 2, wherein the database has a plurality of unique biometric signatures corresponding to staff members stored on the memory means.

14. An apparatus as claimed in claim 1, wherein the user id of the person deactivating the alarm is logged in the memory means of the apparatus.

15. An apparatus as claimed in claim 1, wherein the means for generating the alarm signal has an override function.

16. An apparatus as claimed in claim 1, wherein the alarm output means comprises visual, audible or tactile output means.

17. An apparatus as claimed in claim 1, wherein the clock means, the memory means, the time comparing means and the alarm signal generating means are provided by a microcontroller being operably coupled to the alarm output means and the identification means.

18. An apparatus as claimed in claim 17, wherein a control program is stored on the memory means of the microcontroller.

19. An apparatus as claimed in claim 18, wherein the control program provides comparator means for comparing live user id information from the identification means with user id information stored in the database.

20. An apparatus as claimed in claim 19, wherein the control program provides means for generating a user id authentication signal in response to the comparator means generating a match between live user id information from the identification means and the user ids stored in the database.

21. An apparatus as claimed in claim 18, wherein the control program is in operable communication with a graphical user interface for programming the schedule of tasks.

22. An apparatus as claimed in claim 1, wherein the apparatus has communication means allowing remote access.

23. (canceled)
